(19) United States
(12) Patent Application Publication
(10) Pub. No.: US 2019/0221092 A1
(43) Pub. Date: Jul. 18, 2019

(54) SYSTEMS AND METHODS FOR DETECTING AN UNKNOWN DRONE DEVICE

(71) Applicant: Honeywell International Inc., Morristown, NJ (US)

(72) Inventors: Shankar Prasad Hullahalli Mahadevappa, Bangalore (IN); Basavani Suresh Chidananda, Bangalore (IN); Bharat Balaso Khot, Bangalore (IN); Giridhara Kalkere, Bangalore (IN)

(21) Appl. No.: 15/872,568

(22) Filed: Jan. 16, 2018

(51) Int. Cl. G08B 13/22; B64C 39/02; G08B 13/196; G10L 25/51

(52) U.S. Cl. CPC G08B 13/22; G10L 25/51; G08B 13/19613; B64C 39/024

(57) ABSTRACT

Systems and methods for detecting an unknown drone device are provided. Systems and methods may include identifying a presence of an unidentified drone device within or proximate to a protected area based on sensor data received from at least one sensor device, comparing the sensor data to stored data for known drone devices to determine whether the unidentified drone device is known or unknown, and initiating specific security responses when the unidentified drone is unknown.

### FIELD

The present invention relates generally to systems and methods for detecting an unknown drone device. More particularly, the present invention relates to systems and methods for identifying a presence of an unidentified drone device within or proximate to a protected area based on sensor data received from at least one sensor device, comparing the sensor data to stored data for known drone devices to determine whether the unidentified drone device is known or unknown, and initiating specific security responses when the unidentified drone is unknown.

### BACKGROUND

Known systems and methods for detecting drone devices compare sensor data with standard profile data for known drone devices. However, such systems and methods do not determine whether a particular drone identified by the sensor data is known or unknown or initiate security responses when the particular drone device is unknown.

In view of the above, there is a continuing, ongoing need for improved systems and methods.

### BRIEF DESCRIPTION OF THE DRAWINGS

FIG. 1 is a block diagram of a drone detection system in accordance with disclosed embodiments; and

FIG. 2 is a flow diagram of a method for detecting and responding to an unknown drone device in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein may include systems and methods for identifying and responding to an unknown drone device. For example, systems and methods disclosed herein may include detecting an unidentified drone device, determining whether the unidentified drone device is known or unknown, and when the unidentified drone device is unknown, automatically initiating and executing preprogramed security actions.

Systems and methods as disclosed herein may include individual devices operating together or may be a part of security systems. It is to be understood that such systems can include, but are not limited to systems that include a control panel in communication with one or more sensor devices.

In accordance with disclosed embodiments, at least one sensor device may monitor a secured area, and the control panel or a similar electronic device may identify a presence of the unidentified drone device within or proximate to the secured area based on sensor data received from the at least one sensor device and may compare the sensor data received from the at least one sensor device with stored data for known drone devices associated with the secured area to determine whether the unidentified drone device is known or unknown. Determining whether the unidentified drone device is known or unknown may eliminate false positive determinations where security actions are activated in response to the known drone devices associated with the secured area. Furthermore, responsive to determining that the unidentified drone device is unknown, the control panel may initiate security responses or procedures, such as transmitting a notification signal indicative of the presence of the unidentified drone device, automatically initiating security actions, and monitoring movement of the unidentified drone device.

In some embodiments, the at least one sensor device may include one or both of visual detector devices (e.g. motion sensors, still image cameras, video cameras, IR sensors, etc.) and audio detector devices (e.g. tape recorders, digital recorders, microphones, etc.). In such embodiments, the control panel may identify the presence of the unidentified drone device by comparing the sensor data received from the visual detector devices with standard drone images or movement patterns or by comparing the sensor data received from the audio detector devices with standard drone audio clips or flight sounds.

In some embodiments, the security actions initiated by the control panel may include broadcasting a simulation signal into the secured area to simulate a presence of a user, jamming wireless communications of the unidentified drone device, automatically closing open windows, doors, or blinds in the secured area, attacking the unidentified drone device with at least one of the known drone devices, and following the unidentified drone device with the at least one of the known drone devices to identify an owner of the unidentified drone device. Additionally or alternatively, in some embodiments, the control panel may transmit the notification signal to a central monitoring station to alert local authorities about the unidentified drone device or to a portable user device associated with the secured area to alert a resident or an owner of the secured area about the unidentified drone device. Additionally or alternatively, in some embodiments, the control panel may receive an acknowledgment signal from the central monitoring station or the portable user device and, responsive thereto, may cease monitoring the movement of the unidentified drone device.

In some embodiments, the control panel may identify a type of the unidentified drone device using the sensor data received from the at least one sensor device. Furthermore, in some embodiments, the control panel may use the type of the unidentified drone device to identify or assist in tracking the unidentified drone device, and in some embodiments, the control panel may include the type of the unidentified drone device in the notification signal.

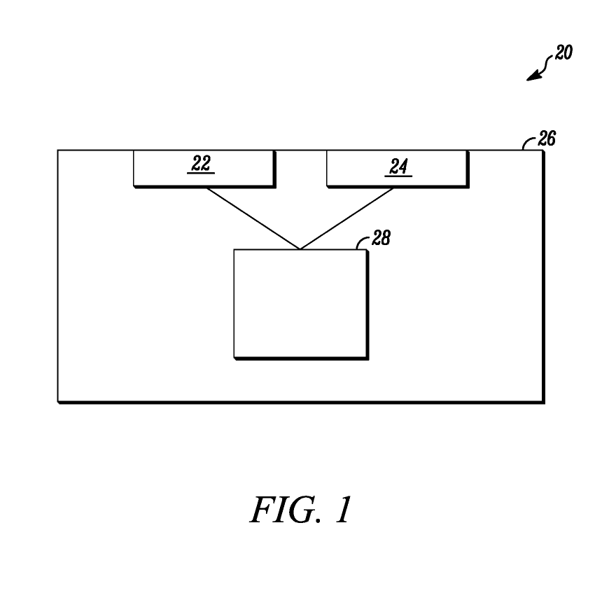

FIG. 1 is a block diagram of a drone detection system 20 in accordance with disclosed embodiments. As shown in FIG. 1, the system 20 may include at least one visual sensor device 22 and at least one audio sensor device 24 monitoring a secured area 26 and a control panel 28 for processing sensor data received from one or both of the at least one visual sensor device 22 and the at least one audio sensor device 24.

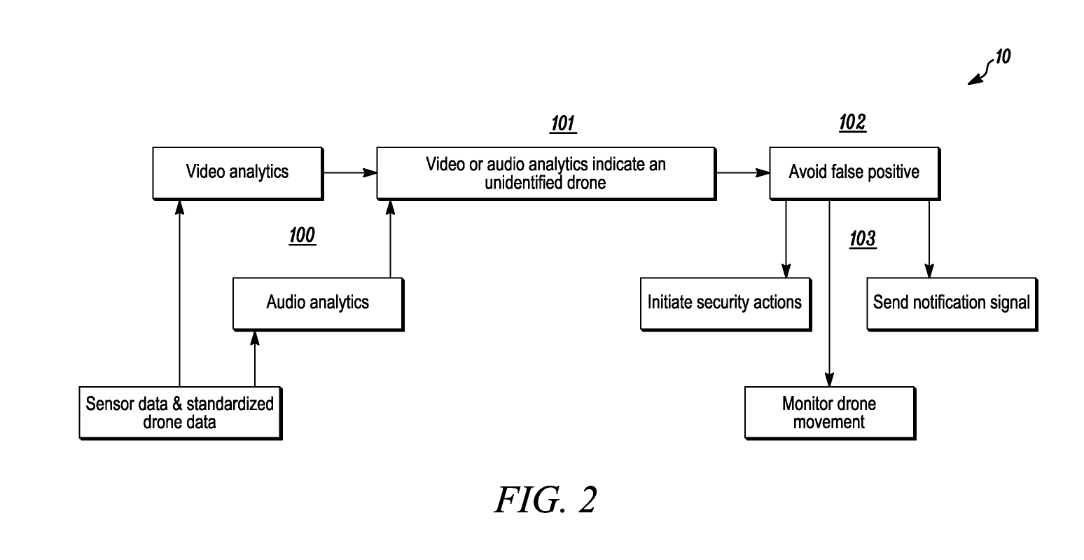

FIG. 2 is a flow diagram of a method 10 in accordance with disclosed embodiments. As shown in FIG. 2, the method 10 may include feeding the sensor data from the at least one visual sensor device 22, the sensor data from the at least one audio sensor device 24, and standardized drone data for known drone devices associated with the secured area 26 into video and audio analytics modules of the control panel 28 as in 100. Furthermore, the method 10 may include the control panel 28 monitoring the sensor data, via the video and audio analytics modules, for content indicative of a presence of an unidentified drone device within or proximate to the secured area as in 101. Responsive to identifying the content indicative of the presence of the unidentified drone device as in 101, the method 10 may include the control panel comparing the sensor data with the standardized drone data for the known drone devices associated with the secured area 26 to determine whether the unidentified drone device is known or unknown and avoid triggering a false positive as in 102. Furthermore, responsive to determining that the unidentified drone device is unknown, the method 10 may include the control panel 28 transmitting a notification signal indicative of the presence of the unidentified drone device, automatically initiating security actions, and/or monitoring movement of the unidentified drone device as in 103.

Although a few embodiments have been described in detail above, other modifications are possible. For example, the steps described above do not require the particular order described or sequential order to achieve desirable results. Other steps may be provided, steps may be eliminated from the described flows, and other components may be added to or removed from the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

1. A method comprising:
a control panel receiving sensor data from at least one sensor device monitoring a secured area;
the control panel identifying a presence of an unidentified drone device within or proximate to the secured area based on the sensor data received from the at least one sensor device;
the control panel comparing the sensor data received from the at least one sensor device with stored data for known drone devices associated with the secured area to determine whether the unidentified drone device is known or unknown;
the control panel identifying a type of the unidentified drone device based on the sensor data received from the at least one sensor device; and
responsive to determining that the unidentified drone device is unknown, the control panel transmitting a notification signal indicative of the presence of the unidentified drone device, automatically initiating security actions, and monitoring movement of the unidentified drone device by using the type of the unidentified drone device to track the unidentified drone device with a known drone device.

2. The method of claim 1 wherein the at least one sensor device includes a visual detector device and the control panel identifying the presence of the unidentified drone device includes the control panel comparing the sensor data received from the at least one sensor device with standard drone images or movement patterns.

3. The method of claim 1 wherein the at least one sensor device includes an audio detector device and the control panel identifying the presence of the unidentified drone device includes the control panel comparing the sensor data received from the at least one sensor device with standard drone audio clips or flight sounds.

4. The method of claim 1 wherein the security actions include at least one of broadcasting a simulation signal into the secured area to simulate a presence of a user, jamming wireless communications of the unidentified drone device, automatically closing open windows, doors, or blinds in the secured area, attacking the unidentified drone device with at least one of the known drone devices, and following the unidentified drone device with the at least one of the known drone devices to identify an owner of the unidentified drone device.

5. The method of claim 1 further comprising the control panel receiving an acknowledgement signal and, responsive thereto, ceasing the monitoring of the movement of the unidentified drone device.

6. The method of claim 1 further comprising the control panel transmitting the notification signal to a portable user device associated with the secured area.

7. The method of claim 1 further comprising the control panel transmitting the notification signal to a central monitoring station.

8. The method of claim 1 further comprising including the type of the unidentified drone device in the notification signal.

9. A system comprising:
at least one sensor device for monitoring a secured area; and
a control panel coupled to the at least one sensor;
wherein the control panel identifies a presence of an unidentified drone device within or proximate to the secured area based on sensor data received from the at least one sensor device, compares the sensor data received from the at least one sensor device with stored data for known drone devices associated with the secured area to determine whether the unidentified drone device is known or unknown, and identifies a type of the unidentified drone device based on the sensor data received from the at least one sensor device, and
wherein, responsive to determining that the unidentified drone device is unknown, the control panel transmits a notification signal indicative of the presence of the unidentified drone device, automatically initiates security actions, and monitors movement of the unidentified drone device by using the type of the unidentified drone device to track the unidentified drone device with a known drone device.

10. The system of claim 9 wherein the at least one sensor device includes a visual detector device and the control panel identifying the presence of the unidentified drone device includes the control panel comparing the sensor data received from the at least one sensor device with standard drone images or movement patterns.

11. The system of claim 9 wherein the at least one sensor device includes an audio detector device and the control panel identifying the presence of the unidentified drone device includes the control panel comparing the sensor data received from the at least one sensor device with standard drone audio clips or flight sounds.

12. The system of claim 9 wherein the security actions include at least one of broadcasting a simulation signal into the secured area to simulate a presence of a user, jamming wireless communications of the unidentified drone device, automatically closing open windows, doors, or blinds in the secured area, attacking the unidentified drone device with at least one of the known drone devices, and following the unidentified drone device with the at least one of the known drone devices to identify an owner of the unidentified drone device.

13. The system of claim 9 wherein the control panel receives an acknowledgement signal and, responsive thereto, ceases monitoring the movement of the unidentified drone device.

14. The system of claim 9 wherein the control panel transmits the notification signal to a portable user device associated with the secured area.

15. The system of claim 9 wherein the control panel transmits the notification signal to a central monitoring station.

16. The system of claim 9 wherein the control panel includes the type of the unidentified drone device in the notification signal.

17. A method comprising:
at least one visual sensor device monitoring a secured area;
at least one audio sensor device monitoring the secured area;
a control panel receiving sensor data from the at least one visual sensor device or the at least one audio sensor device;
the control panel monitoring the sensor data for content indicative of a presence of an unidentified drone device within or proximate to the secured area;
responsive to identifying the content indicative of the presence of the unidentified drone device, the control panel comparing the sensor data with stored data for known drone devices associated with the secured area to determine whether the unidentified drone device is known or unknown and using the sensor data received from the at least one visual sensor device or the at least one audio device to identify a type of the unidentified drone device; and
responsive to determining that the unidentified drone device is unknown, the control panel transmitting a notification signal indicative of the presence of the unidentified drone device, automatically initiating security actions, and monitoring movement of the unidentified drone device by using the type of the unidentified drone device to track the unidentified drone device with a known drone device.

18. The method of claim 17 wherein the content indicative of the presence of the unidentified drone device includes standard drone images, standard drone movement patterns, standard drone audio clips, or standard drone flight sounds.

19. The method of claim 17 wherein the security actions include at least one of broadcasting a simulation signal into the secured area to simulate a presence of a user, jamming wireless communications of the unidentified drone device, automatically closing open windows, doors, or blinds in the secured area, attacking the unidentified drone device with at least one of the known drone devices, and following the unidentified drone device with the at least one of the known drone devices to identify an owner of the unidentified drone device.

20. The method of claim 17 further comprising the control panel receiving an acknowledgement signal and, responsive thereto, ceasing the monitoring of the movement of the unidentified drone device.
